(19) United States
(12) Patent Application Publication
(10) Pub. No.: US 2014/0143102 A1
(43) Pub. Date: May 22, 2014

(54) CONTROL SYSTEM AND METHOD WITH USER INTERFACE

(71) Applicant: GENERAL ELECTRIC COMPANY, Schenectady, NY (US)

(72) Inventor: David BELL, Atlanta, GA (US)

(73) Assignee: GENERAL ELECTRIC COMPANY, Schenectady, NY (US)

(21) Appl. No.: 13/682,333

(22) Filed: Nov. 20, 2012

(51) Int. Cl. G06Q 40/00

(52) U.S. Cl. CPC G06Q 40/10
USPC 705/30

(57) ABSTRACT

Systems and methods providing a user interface to facilitate at least the accessing, the reviewing, and the analyzing of owner asset transaction data. Embodiments of the present invention provide a controller having a communication device and a user interface. The communication device is operable to receive owner asset transaction data for a plurality of owner asset. The user interface is operable to facilitate access of the owner asset transaction data by a user and the investigation of discrepancies between the owner asset transaction data and, for example, industry standard transaction data.

### BACKGROUND

1. Technical Field

Embodiments of the subject matter disclosed herein relate to methods and systems providing a user interface to facilitate the accessing, the reviewing, and the analyzing of owner asset transaction data.

2. Discussion of Art

Assets that are owned or leased by an entity may need to be managed and tracked for the purposes of billing and payment with respect to the use of those assets. For example, with respect to railroad assets, a first railroad may own its own fleet of rail cars, and may keep track of all rail car assets traveling on its railroad tracks, whether or not the rail car assets are owned by that first railroad. Furthermore, at the end of a billing period (e.g., end of the month), the first railroad may make payment through a central clearing house to other railroads that had their rail cars traveling on the railroad tracks of the first railroad during that billing period. That is, the rail cars are owned by other railroads but traveling on the tracks of the first railroad may be deemed leased by the first railroad. Such payments may be made to compensate the other railroads for use of their rail cars to ship products and materials on the railroad tracks of the first railroad. Each railroad receives payment along with other associated owner asset transaction data (receivables data) corresponding to their rail cars that traveled on railroad tracks of other railroads. The owner asset transaction data may include payment data, mileage rate data, distance traveled data, time of use data, payee information, asset type information, asset cargo type, reclaims information, and shipper/consignee information, for example. The number of transactions and the associated number of assets (e.g., rail cars) can be quite large and mistakes can be made when tracking assets and making payment for use of assets on a railroad's tracks. Therefore, it may be desirable to allow an asset owner (e.g., a railroad or an asset leasing company) to be able to verify the use of its assets and the payments for the use of its assets by analyzing the received owner asset transaction data.

### BRIEF DESCRIPTION

Systems and methods providing a user interface to facilitate at least the accessing, the reviewing, and the analyzing of owner asset transaction data are disclosed. Embodiments of the invention may provide a controller to receive owner asset transaction data and allow a user to view transaction details down to the individual asset level, if desired, and to research one more transactions related to one or more assets. This may be done through a controller having a user interface. The user interface allows a user to investigate asset transactions by category such as, for example, an asset fleet category, an asset type category, or an individual asset category. Other categories are possible as well, in accordance with various embodiments.

In one embodiment, a controller is provided that includes a communication device operable to receive owner asset transaction data for a plurality of owner assets, and a user interface operable to facilitate access of the owner asset transaction data by a user. The user interface may be operable to facilitate access of the owner asset transaction data by a user according to category. The categories may include one or more of an asset fleet category, an asset type category, and an individual asset category. The user interface may facilitate access of the owner asset transaction data by a user at a transaction level for a group of assets or for an individual asset. In accordance with an embodiment, the plurality of owner assets may be leasable and may include vehicles or powered equipment. The vehicles or powered equipment may include at least one of rail cars, construction vehicles or equipment, mining vehicles or equipment, communication vehicles or equipment, shipping vehicles or equipment, or transportation vehicles or equipment, for example. The user interface may be operable to facilitate a comparison of the owner asset transaction data to a set of industry standard transaction data. The user interface may be operable to facilitate investigation of a deviation in the owner asset transaction data from the industry standard transaction data. The user interface may be operable to facilitate a generation of a claim based on the deviation in the owner asset transaction data. The user interface may facilitate a comparison of at least a portion of asset movement data, as recorded in the owner asset transaction data, to asset movement data obtained from a source other than that from the owner asset transaction data, or to asset time and location data.

In one embodiment, a method includes detecting discrepancies between received owner asset transaction data and modeled or empirical transaction data. At least one of the owner asset transaction data, the modeled or empirical data, and discrepancy data associated with the detected discrepancies may be selectably displayed. Details associated with the discrepancy data may be subsequently investigated. A detected discrepancy may relate to one of an asset rate, and asset time of use, and asset distance traveled, or an asset payment. Discrepancy data may be in the form of differential data, for example. Comparison may be provided in contrast to actual data collected or against a rule set.

In one embodiment, received owner asset transaction data is compared to at least one of modeled transaction data or empirical transaction data to identify a discrepancy; and displaying selectably in response to an identified discrepancy at least one of: the owner asset transaction data, the modeled transaction data, or the empirical transaction data in addition to discrepancy data that is associated with the detected discrepancy

A claim may be generated that is associated with the discrepancy data. Details associated with claims history including claims paid, claims outstanding, and claims denied associated with one or more of a plurality of owner assets associated with the owner asset transaction data may be investigated. The owner asset transaction data may include one or more of asset rate data, asset time of use data, asset distance traveled data, asset payment data, payee information, asset type information, asset cargo type, reclaims information, and shipper/consignee information.

In one embodiment, a controller is provided that includes a communication device operable to receive owner asset transaction data for a plurality of owner assets, and a processing device or processor that includes a module to compare the owner asset transaction data to expected transaction data to detect discrepancies. The controller includes a user interface. The user interface can retrieve, organize, and selectively display at least a portion of the owner asset transaction data, the expected transaction data, and discrepancy data associated with the discrepancies.

### BRIEF DESCRIPTION OF THE DRAWINGS

Reference is made to the accompanying drawings in which particular embodiments of the invention are illustrated as described in more detail in the description below, in which:

FIG. 1 is a diagram illustrating the concept of assets transitioning across routes owned by different route owners, creating the need for payments by route owners for the use of the assets on their routes;

FIG. 2 is a schematic block diagram of an exemplary embodiment of a system having a controller providing a user interface to facilitate the accessing, the reviewing, and the analyzing of owner asset transaction data;

FIG. 3 illustrates a flow chart of an exemplary embodiment of a method for detecting and analyzing discrepancies associated with owner asset transaction data using the user interface provided by the system of FIG. 1;

FIG. 4 illustrates an exemplary embodiment of a screen shot of an inquiry screen provided by the user interface of the system of FIG. 1 showing multiple months of asset payment information (e.g., car hire payment information) with menu-selectable options to levels of additional detail along several paths;

FIG. 5 illustrates an exemplary embodiment of a screen shot of an inquiry screen provided by the user interface of the system of FIG. 1 showing information that is available when a user selects a menu option to go to a paying asset owner level of information (e.g., a car hire paying railroad level of information);

FIG. 6 illustrates an exemplary embodiment of a screen shot provided by the user interface of the system of FIG. 1 showing the ability to view default and negotiated asset use (e.g., car hire) rates for individual assets (e.g., rail cars) or selected asset mark groups (e.g., rail car mark groups);

FIG. 7 illustrates an exemplary embodiment of a screen shot of an inquiry screen provided by the user interface of the system of FIG. 1 showing asset claim details (e.g., car hire claim details) on claims outstanding for a particular asset mark (e.g., railroad car mark);

FIG. 8 illustrates an exemplary embodiment of a screen shot provided by the user interface of the system of FIG. 1 showing detailed asset cycle information (e.g., car cycle information) for a selected claim that allows a user to ensure the validity of a time shortfall being claimed before the claim is issued;

FIG. 9 illustrates an exemplary embodiment of a screen shot provided by the user interface of the system of FIG. 1 showing detailed asset rate information (e.g., car hire rate information) for a selected claim that allows a user to ensure that correct asset rates (e.g., car hire rates) were used in the calculation of a claim before the claim is issued;

FIG. 10 illustrates an exemplary embodiment of a screen shot provided by the user interface of the system of FIG. 1 showing graphs of utilization, earnings, and revenue percentages for a fleet of assets (e.g., a fleet of rail cars);

FIG. 11 illustrates an exemplary embodiment of a screen shot provided by the user interface of the system of FIG. 1 showing a side-by-side comparison of asset receivable information (e.g., car hire receivable information) for a plurality of asset contracts over two years;

FIG. 12 illustrates a first exemplary embodiment of a screen shot provided by the user interface of the system of FIG. 1 showing graphs and tables of asset receivable information (e.g., car hire receivable information) for a particular month; and

FIG. 13 illustrates a second exemplary embodiment of a screen shot provided by the user interface of the system of FIG. 1 showing graphs and tables of asset receivable information (e.g., car hire receivable information) for a particular month.

### DETAILED DESCRIPTION

Embodiments of the invention may relate to methods and systems for providing a user interface to facilitate accessing, reviewing, and analyzing owner asset transaction data. Such transaction data may include, for example, car hire receivable data.

The term “asset” refers to equipment and materials that may be owned, leased, and transported. Examples of assets include, but are not limited to, rail cars of a railroad or a rail car leasing company, vehicles or powered equipment, wherein the vehicles or powered equipment include at least one of locomotives, construction vehicles or equipment, mining vehicles or equipment, communication equipment, shipping vehicles or equipment, or transportation vehicles or equipment.

A rail vehicle consist is a group of rail vehicles that are mechanically linked together to travel along a track. A train is one example of a rail vehicle consist. Another example is a set of mining ore carts. A vehicle consist, more generally, is a group of vehicles that are mechanically linked together to travel along a route. A powered vehicle consist refers to the interaction of two or more powered vehicles that are mechanically linked together, as may be the case for a locomotive consist (providing multiple powered vehicles to move a train of otherwise unpowered vehicles). Although trains are often referred to herein, certain embodiments are more generally applicable to rail vehicle consists or other vehicle consists.

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer”, “processor”, “processing device” or “computer device” as used herein includes, but is not limited to, a programmed or programmable electronic device that can store, retrieve, and process data. “Non-transitory computer-readable media” include, but are not limited to, a CD-ROM, a removable flash memory card, a hard disk drive, a magnetic tape, and a floppy disk. “Controller”, as used herein, refers to a system that includes the logic circuitry, memory, and/or processing devices and associated software, modules or programs. The term “communication device” as used herein may refer to any wired or wireless device (e.g., a computer modem) operable to receive and/or transmit signals, data, or information.

The term “transaction data” or “transaction information” as used herein may refer to data or information related to the use of assets by various entities and the monetary payments associated with the use of those assets. The term “user interface” as used herein may refer to the software, the display screens, and the functionality provided by embodiments of the present invention that facilitate at least the accessing, the reviewing, and the analyzing of owner asset transaction data by a user. The term “claim” as used herein may refer to the claims of this patent application or to a computerized demand for correct or corrected payment for use of an asset. The term “Screen shot” is a picture of a screen at a moment in time, and a “User Interface” is a display of a series of Screen Shots, and which may be interactive to display different information depending on user input and underlying information. The User Interface, depending on context, may include the graphical input/output and/or the display hardware.

The system and methods described herein may be discussed in the context of rail car assets and corresponding car hire receivable transaction information. However, embodiments may apply to other assets and owner asset transaction information. Such other assets may include, for example, construction vehicles or equipment, mining vehicles or equipment, communication vehicles or equipment, shipping vehicles or equipment, or transportation vehicles or equipment.

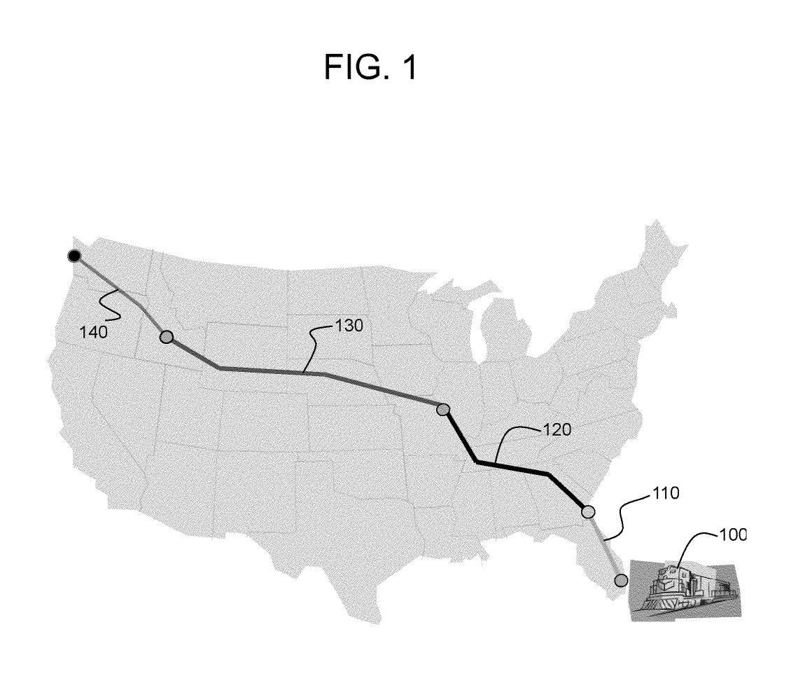

FIG. 1 is a diagram illustrating the concept of assets transitioning across routes owned by different route owners, creating the need for payments by route owners for the use of the assets on their routes. For example, a train 100 of rail cars owned by a first railroad that is making its way across the country may travel along a first route 110 owned by the first railroad, then a second route 120 owned by a second railroad, followed by a third route 130 owned by a third railroad, and finally a fourth route 140 owned by a fourth railroad. As the train travels across the country, each railroad tracks the rail cars of the train on its route (on its railroad tracks) and gathers associated information such as, for example, time stamps and distance traveled by each car. A railroad may use, for example, radio frequency identification (RFID) or Automatic Equipment Identification (AEI) technology to aid in tracking cars on its routes. Assets (e.g., rail cars) may also be leased by a railroad or a shipping company from a third party leasing company. In such a scenario, the third party leasing company is the owner of the assets, and the user may be a leasee or lessee with a contractual agreement with the asset owner. In some instances, a bailment arrangement or the like may be substituted for a formal lease.

Because the rail cars are owned by the first railroad, the subsequent (i.e., second, third, and fourth) railroads may each (e.g., at the end of the month) owe and pay the first railroad for use of the first railroad's rail cars on the tracks or routes of the other railroads, respectively. Such payments may be made through a central clearing house which accepts the payments and associated rail car data from the various railroad entities. The central clearing house may then process the rail car data and the payments to form car hire receivable information (a type of owner asset transaction data) for the first railroad. The car hire receivable information may be sent to the first railroad or made available to the first railroad via a computer network (e.g., the internet).

Each railroad may keep track of assets owned by other railroads (or equipment of other entities such as leasing companies) traveling on its railroad tracks and subsequently provide payment and associated rail car information to the central clearing house, for example, at the beginning or the end of each month. When a railroad receives or accesses the car hire receivable information for a particular time period as gathered by the central clearing house, the railroad may desire to review the car hire receivable information to check for any errors or discrepancies with respect to use of their rail cars on other railroads and the associated payments.

Such errors or discrepancies may relate to an asset rate, an asset time of use, an asset distance traveled, or an asset payment. An asset rate may correspond to a monetary charge per mile or a monetary charge per hour along a route, for example. An asset time of use may correspond to a total time that a rail car was on another railroad's track, for example. An asset distance traveled may correspond to a total distance that a rail car traveled along another railroad's track, for example. Other types of discrepancies may be possible as well. The parameters listed may be bounded in a determined manner. For example, asset distance traveled may be bounded for a particular trip, for a particular time, or for a particular transaction. Bounding for a particular transaction may be a cumulative distance calculated while in the possession of a user regardless of the actual distance or use or period of time in which the asset is in the possession of the user.

For example, if the transaction data states an asset was in use in a certain time and place, actual time and location data of the asset may be used to confirm the statement. If, on the other hand, there is no precise confirmation available then a rule set may be used. In such an example, one or more known data points (such as the location of the asset at a different time) may be used with a logic set (such as whether the asset could have traveled the distance from the known time/location to the billed transaction location in the time provided as the difference between the billed time and the known time/location).

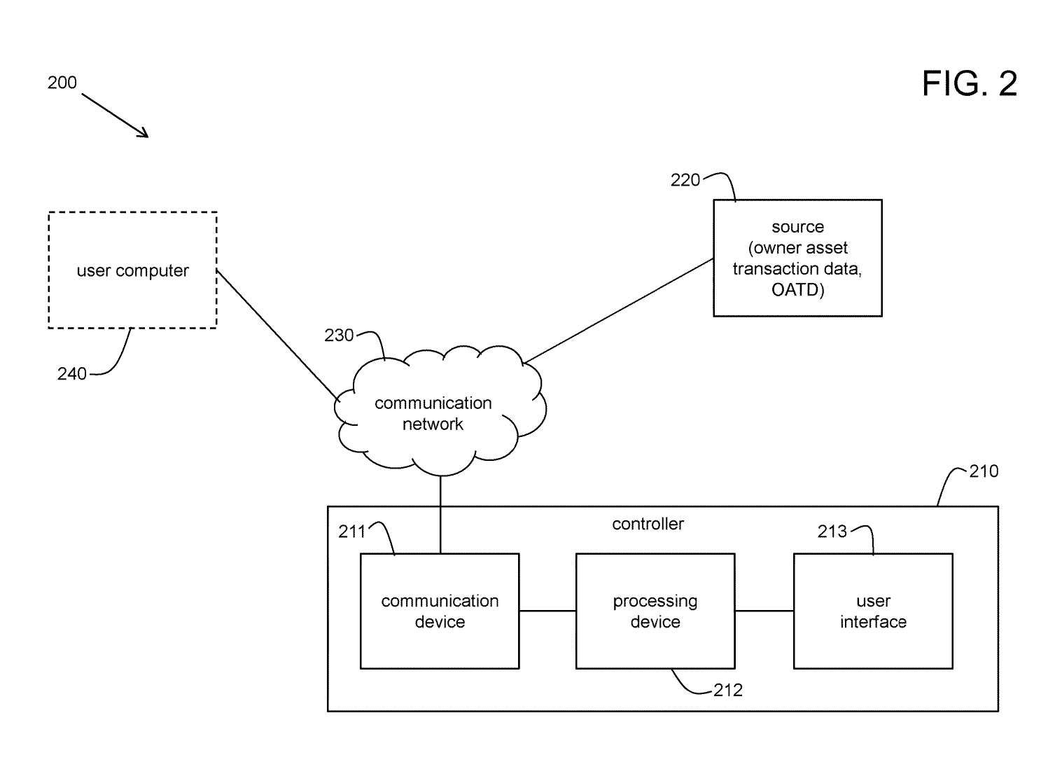

FIG. 2 is a schematic block diagram of an exemplary embodiment of a system 200 having a controller 210 (with a communication device 211 and processing device 212) providing a user interface 213 to facilitate at least the accessing, the reviewing, and the analyzing of owner asset transaction data. The system includes the control system and a source 220 of owner asset transaction data (OATD). The system includes the communication device that interacts with a communication network 230 allowing the controller to communicate with the source (e.g., access data from the source). The source may be a database server computer for example, storing owner asset transaction data (e.g., car hire receivable data) for an owner (e.g., for a railroad owner). The communication network may be the internet, for example. Other sources, databases, and communication networks may be included, in accordance with other embodiments.

The controller includes the communication device, the processing device, and a user interface 213. The communication device may be, for example, a computer modem allowing communication between the controller and the communication network. The processing device may be, for example, a software-programmable microprocessor. In accordance with an embodiment, the user interface is a graphical user interface and is a configuration of software functionality and user-interactive screen shots that facilitate the accessing, the reviewing, and the analyzing of owner asset transaction data (e.g., car hire receivable data) by a user. The user interface may allow requests of owner asset transaction data according to category. Categories may include, for example, an asset fleet category, an asset type category, and an individual asset category.

The user interface may be a web-based graphical user interface (GUI) and may include the display hardware in some implementations. Use of the GUI may provide access to owner asset transaction information, including reclaims. Direct access to rolling summaries of car hire information may be provided with one-click drill-down to details. Such details may include payee, asset type, asset cargo type, reclaims, shipper/consignee, and pool. The rolling summaries may be set for determined periods. Such periods may align with, for example, one or two calendar years, fiscal years, current or previous months, and the like. Owner asset transaction data may be compared to estimates based on actual car movements, including mileage and reclaims, for example. Estimates and forecasts may be produced weekly, monthly, or yearly for example.

The user interface provides a claims processing interface that includes a detailed history of claims that includes claims paid, claims outstanding, and claims denied. The processing device may track paid claims, outstanding claims, and denied claims associated with the owner assets. The processing device is further operable to perform claim rectification and to confirm receipt of claims communications associated with the owner assets. The user interface includes ready access to asset movement events and rates for the purpose of researching claims. A large library of reports may be provided to aid in analysis. The ability to create ad-hoc reports is provided and reports may be exported to other applications. The user interface may provide a dashboard view. Such a dashboard view may allow a user to review and analyze trends and problem areas. For example, the processing device may calculate trends of cost over time associated with one or more of the plurality of owner assets. The user interface may present graphical depictions of the trends of cost over time.

The user interface 213 may include a touch-screen display for viewing and interacting with the screen shots, for example. Alternatively or optionally, the system may include a user computer 240 (e.g., a personal computer, tablet, smart phone, and the like) having a display and a mouse, for example, that is used to access, view, and interact with the user interface. The user computer may interface directly to the controller or may have a web browser allowing interfacing via a computer network (e.g., the communication network). In such an alternative embodiment, the controller may be structured in a software-as-a-service (SaaS) configuration. A user may have an account and security authentication to log into the SaaS controller.

The controller may access car hire receivable data from the source via the communication network. A user may then review and analyze the car hire receivable data using the controller as facilitated by the user interface of the controller. In accordance with an embodiment, the user interface is configured to allow a user to review the car hire receivable data at various levels of transaction detail from a highest summary level (e.g., a level corresponding to an entire fleet of assets) down to the level of an individual asset (e.g., an individual rail car). The user interface allows a user to view trends, make sense of transactions, research claims and rates, track rates, and process other transactions such as re-claims and counter re-claims.

In accordance with an embodiment, the control system or controller 210 may detect discrepancies or deviations between owner asset transaction data and industry standard transaction data (or modeled or empirical transaction data), allow a user to investigate the details of the discrepancy, and allow a user to initiate the generation of a claim to correct the discrepancy. For example, if payments by a railroad using a rail car to the owning railroad were made using an incorrect mileage rate for that rail car, the processor can detect that discrepancy, alert the owner to the discrepancy, and allow the owner to investigate details associated with the discrepancy. The processor can generate a claim to correct the discrepancy for that rail car by requesting an adjustment in payment from the other railroad (e.g., through the central clearing house). Further, a follow up module can indicate when a discrepancy is actually rectified.

In accordance with an embodiment, the control system can compare at least a portion of asset movement data as recorded in the owner asset transaction data to asset movement data obtained from a different source other than that from the owner asset transaction data or to asset time and location data. The user interface may facilitate such a comparison. Suitable asset movement data may be, for example, related to the movement of rail cars along routes. Suitable sources of asset movement data may be, for example, global positioning system (GPS) data as acquired for each asset independently of the owner asset transaction data. The interface can be a .NET based application that interacts with a DB2 database.

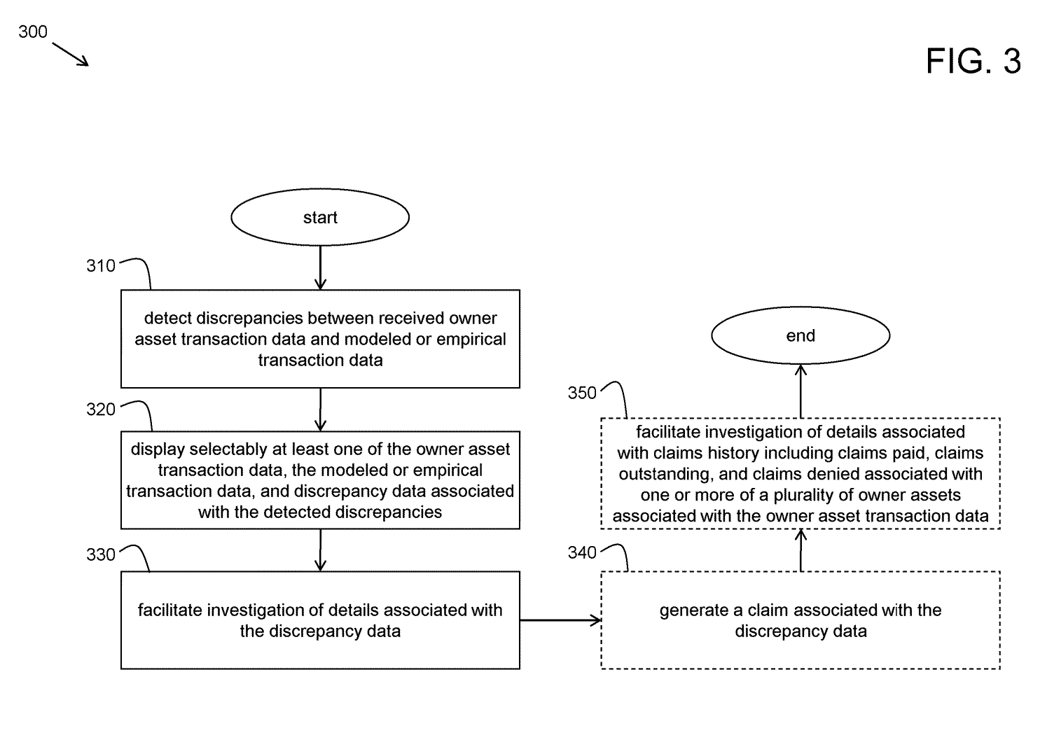

FIG. 3 illustrates a flow chart of an embodiment of a method 300 for detecting and analyzing discrepancies associated with owner asset transaction data using the user interface 213 provided by the system 200 shown in FIG. 2. In step 310, discrepancies are detected between received owner asset transaction data and modeled or empirical transaction data (or industry standard data) by the controller. The modeled or empirical transaction data may be characterized as expected transaction data. In accordance with an embodiment, the processing device 212 of the controller 210 compares the owner asset transaction data to the modeled or empirical transaction data to detect any discrepancies. In step 320, at least one of the owner asset transaction data, the modeled or empirical transaction data, and the discrepancy data associated with the detected discrepancies may be selected by the user and displayed via the user interface. Discrepancy data may be in the form of, for example, difference data related to the numerical difference between owner asset transaction data and modeled or empirical transaction data.

In step 330, the user may employ the user interface to investigate details associated with the discrepancy data. As an option, in step 340 the user may employ the user interface to initiate the generation of a claim by the processing device, where the claim is associated with the discrepancy data. Furthermore, as an option, in step 350 the user may employ the user interface to facilitate the investigation of details associated with claims history. The claims history may include claims paid, claims outstanding, and claims denied that are associated with one or more of a plurality of owner assets associated with the owner asset transaction data. In accordance with an embodiment, the user interface 213 includes software instructions that are executed on the processing device 212.

As described herein, the user interface 213 may perform various functions at the command of the user. For example, the user interface may retrieve, organize, and selectively display at least a portion of the owner asset transaction data, standard transaction data, expected transaction data, modeled or empirical transaction data, and discrepancy data. The user interface facilitates user interaction with at least a portion of the data to allow investigation of details associated with detected discrepancies and claims. Again, the user interface 213 is configured to allow a user to review the transaction data and any associated discrepancy data at various levels of transaction detail from a highest summary level down to the level of an individual asset. The screen shots described below illustrate various aspects of the user interface 213 of the controller 210.

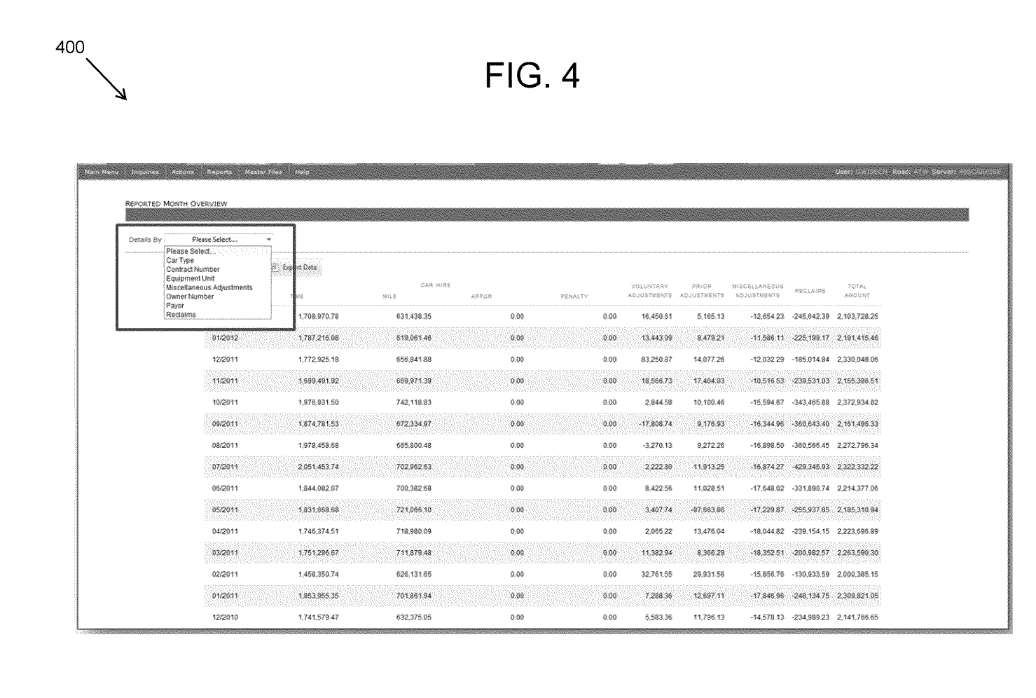

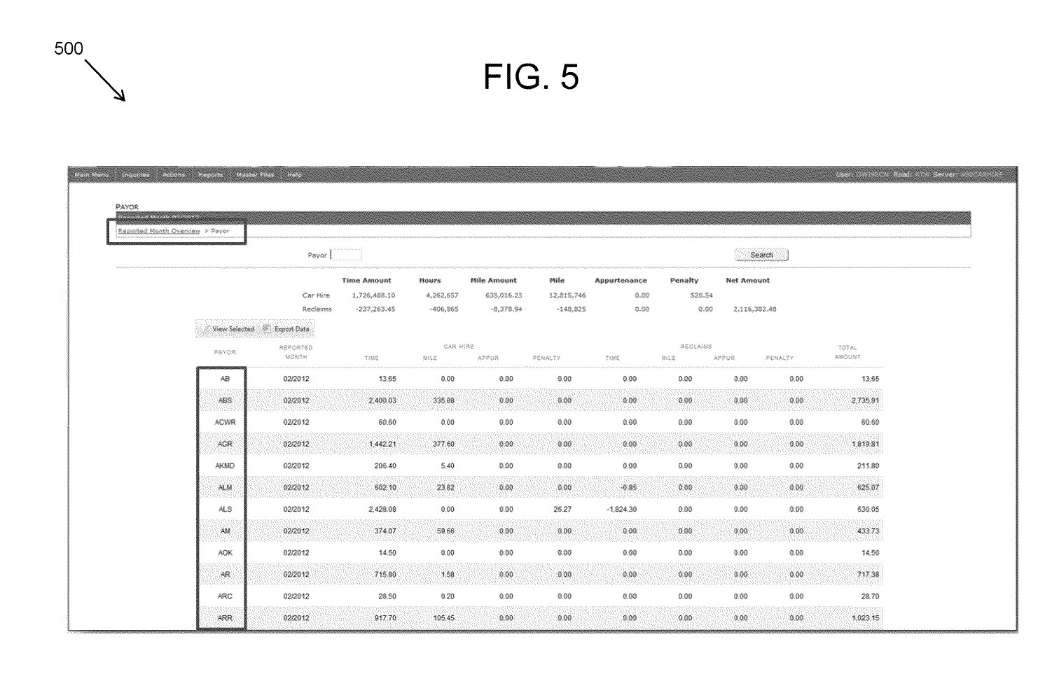

FIG. 4 illustrates an exemplary embodiment of a screen shot 400 of an inquiry screen provided by the user interface 213 of the system 200 of FIG. 2 showing multiple months of asset payment information (e.g., car hire payment information) with menu-selectable options to levels of additional detail along several paths. The several paths include car type, contract number, equipment unit, miscellaneous adjustments, owner number, payor, and reclaims. Other paths such as, for example, area or geography may be possible as well. FIG. 5 illustrates an exemplary embodiment of a screen shot 500 of an inquiry screen provided by the user interface 213 of the system 200 of FIG. 2 showing information that is available when a user selects a menu option to go to a paying asset owner (payor) level of information (e.g., a car hire paying railroad level of information).

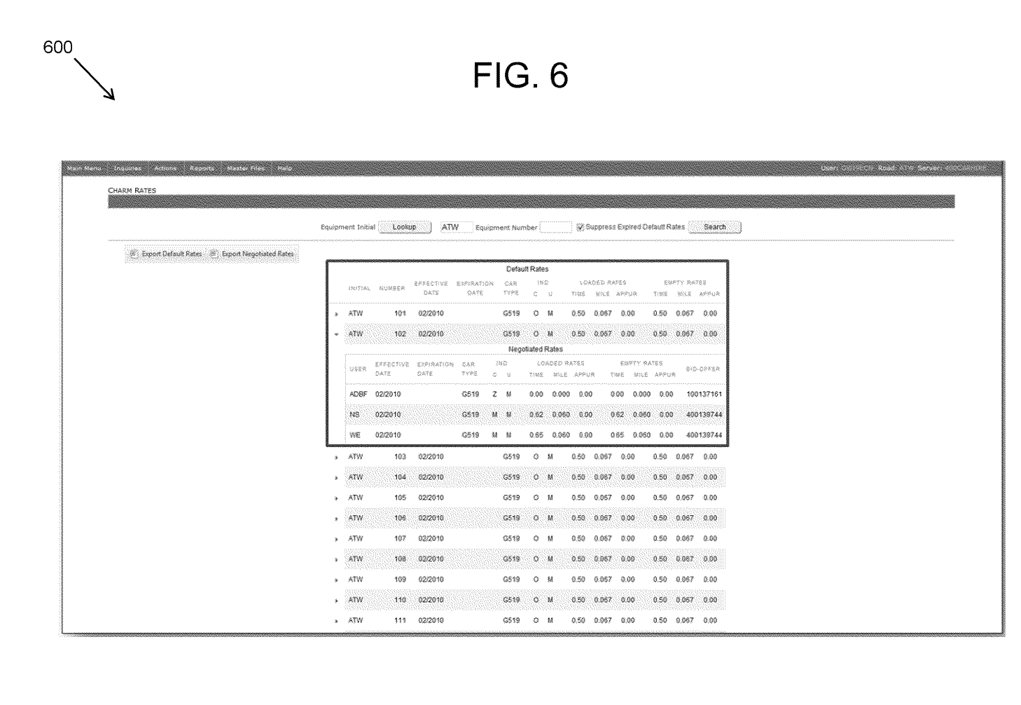

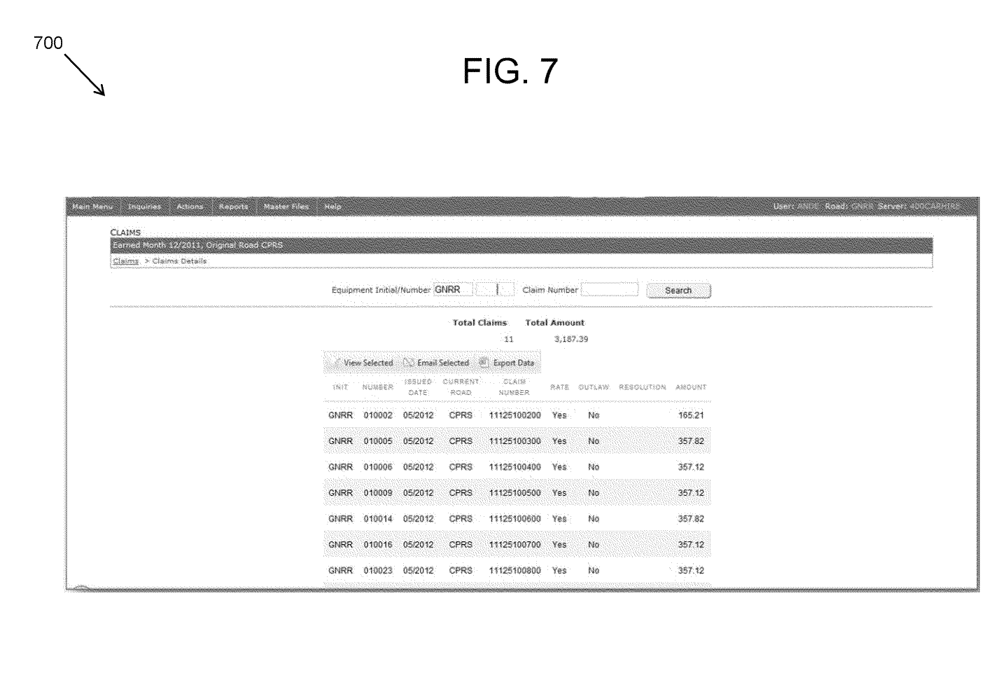

FIG. 6 illustrates an exemplary embodiment of a screen shot 600 provided by the user interface of the system shown in FIG. 2 showing the ability to view default and negotiated asset use rates (e.g., car hire rates) for individual assets (e.g., rail cars) or selected asset mark groups (e.g., rail car mark groups). FIG. 7 illustrates an exemplary embodiment of a screen shot 700 of an inquiry screen provided by the user interface of the system of FIG. 2 showing asset claim details (e.g., car hire claim details) on claims outstanding for a particular asset mark (e.g., a railroad car mark).

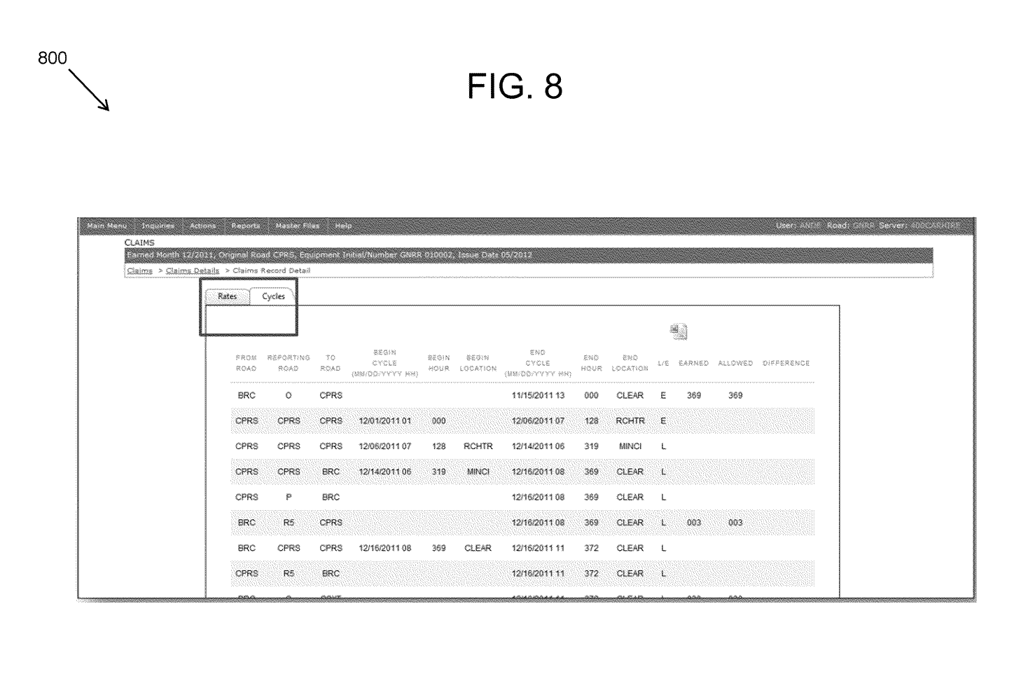

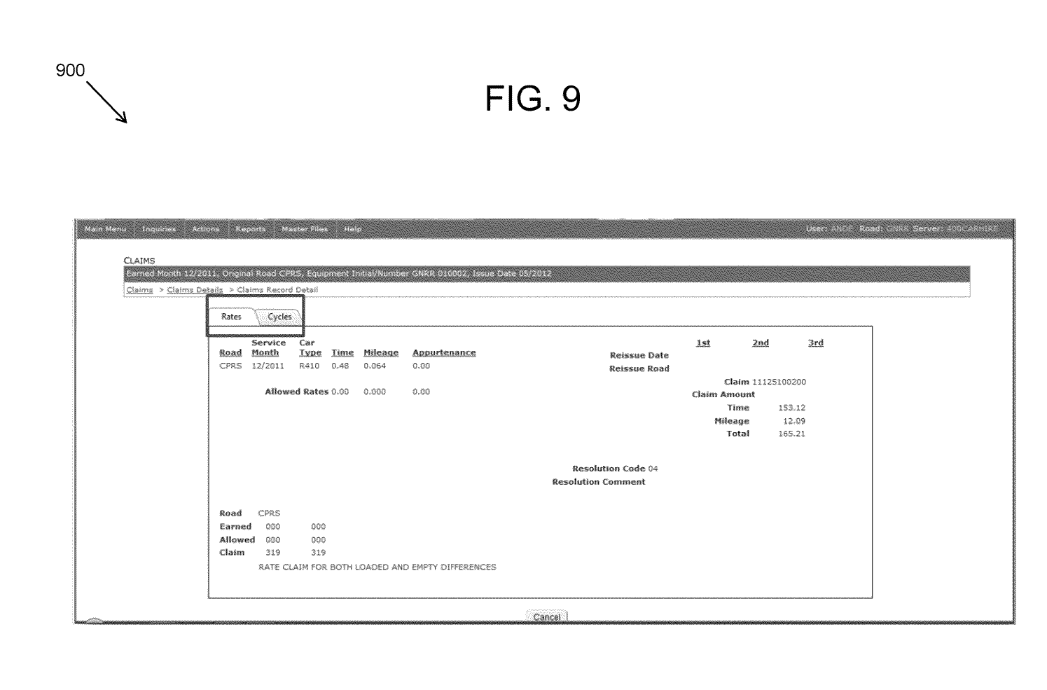

FIG. 8 illustrates an exemplary embodiment of a screen shot 800 provided by the user interface of the system of FIG. 2 showing detailed asset cycle information (e.g., car cycle information) for a selected claim that allows a user to ensure the validity of a time shortfall being claimed before the claim is issued. FIG. 9 illustrates an exemplary embodiment of a screen shot 900 provided by the user interface of the system of FIG. 2 showing detailed asset rate information (e.g., car hire rate information) for a selected claim that allows a user to ensure that correct asset rates (e.g., car hire rates) were used in the calculation of a claim before the claim is issued.

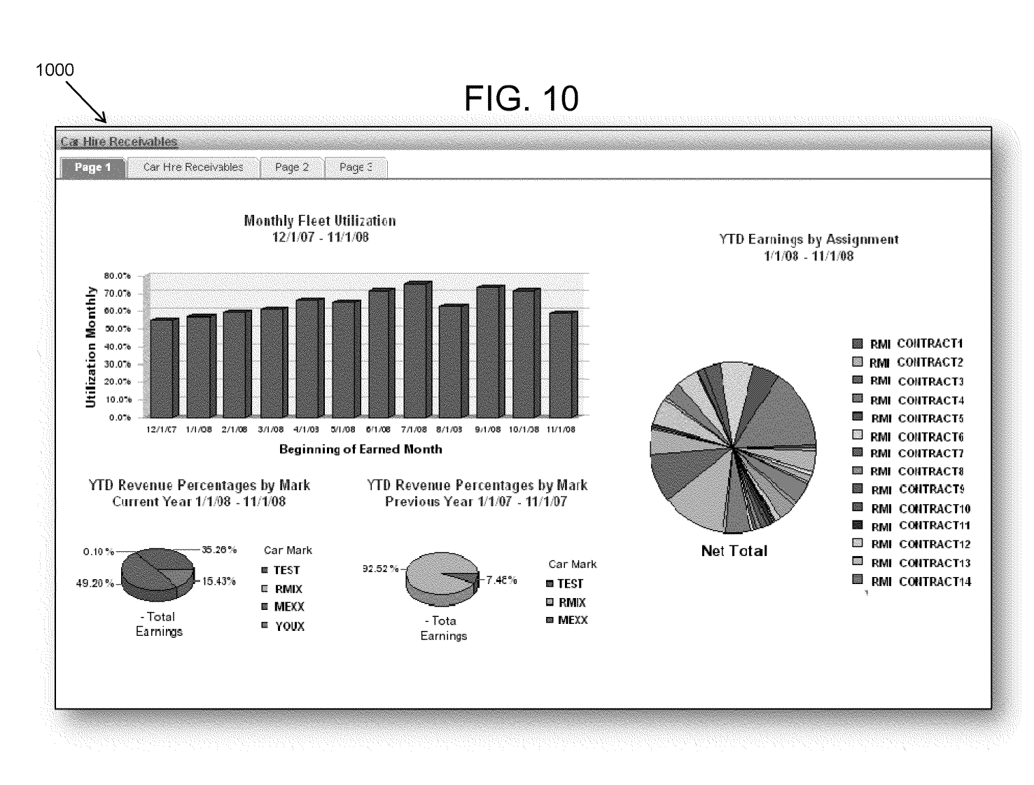

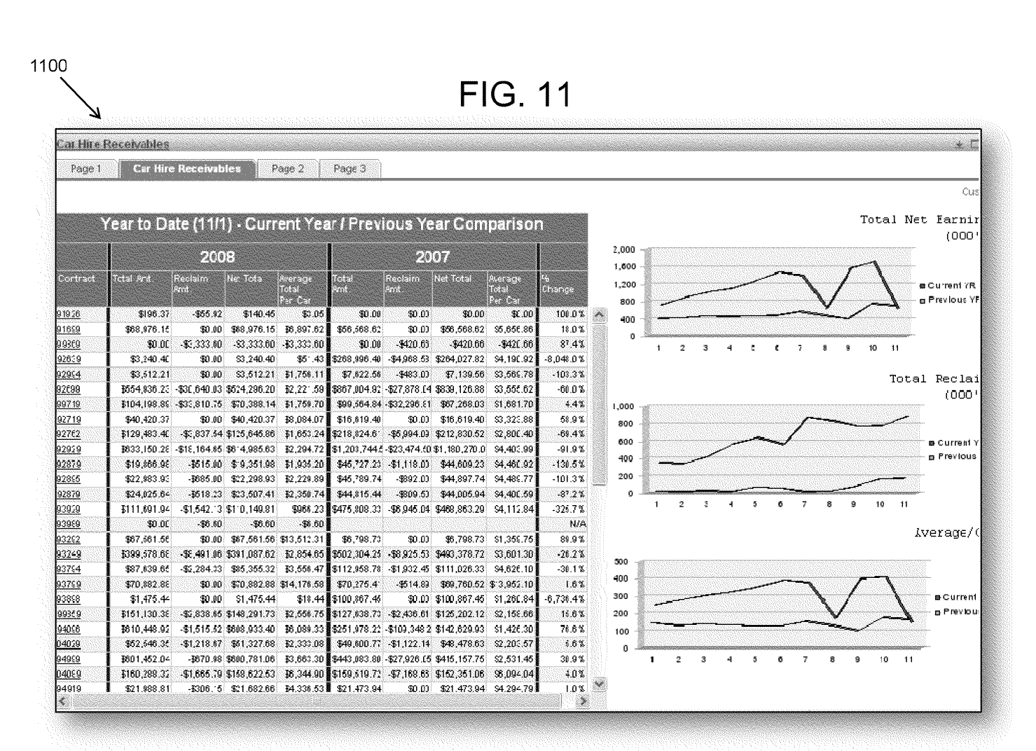

FIG. 10 illustrates an exemplary embodiment of a screen shot 1000 provided by the user interface of the system of FIG. 2 showing graphs of utilization, earnings, and revenue percentages for a fleet of assets (e.g., a fleet of rail cars). FIG. 11 illustrates an exemplary embodiment of a screen shot 1100 provided by the user interface of the system 200 of FIG. 2 showing a side-by-side comparison of asset receivable information (e.g., car hire receivable information) for a plurality of asset contracts for two consecutive years.

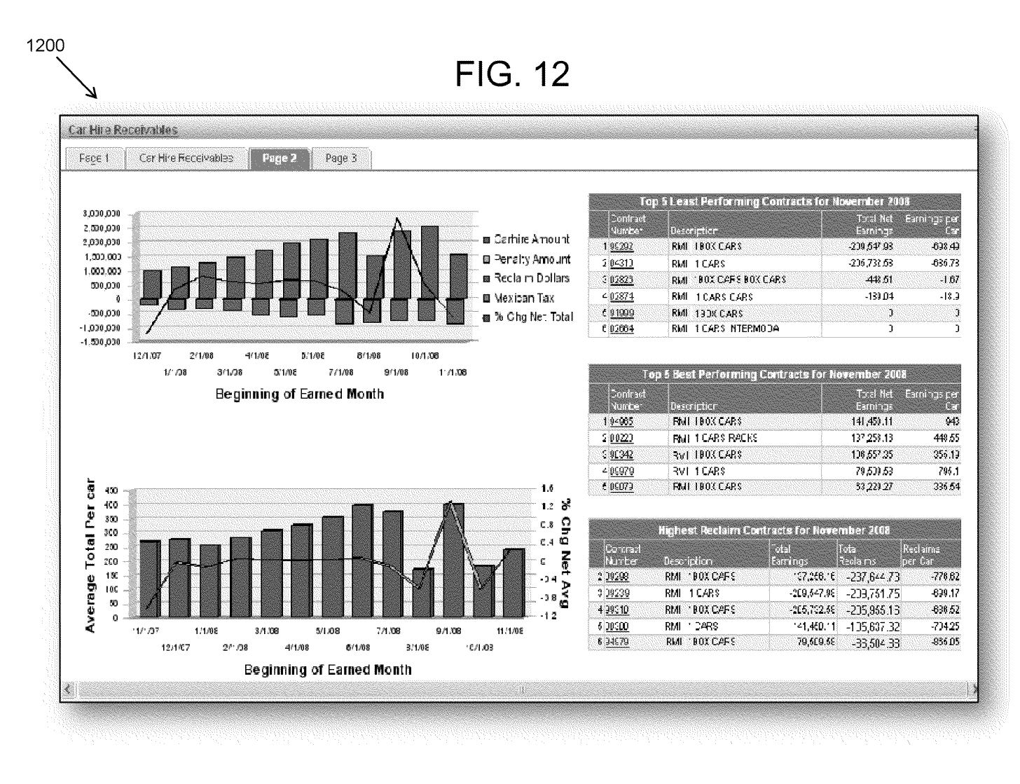

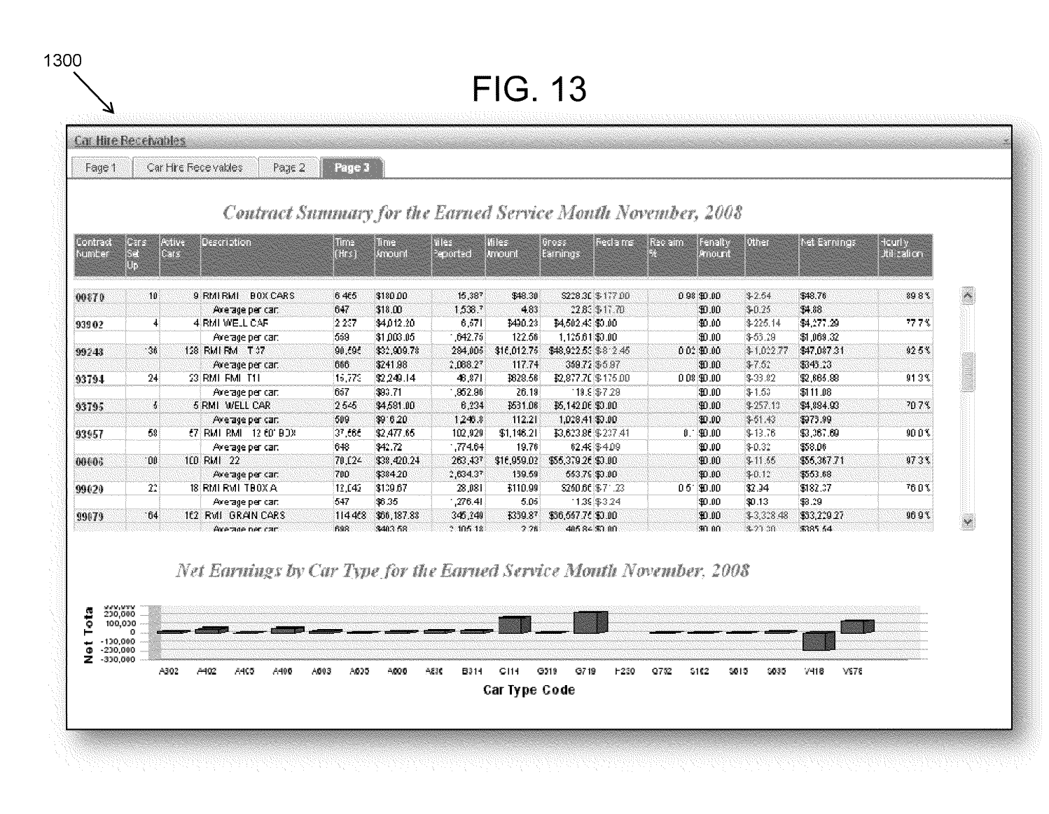

FIG. 12 illustrates a first exemplary embodiment of a screen shot 1200 provided by the user interface of the system as shown in FIG. 2 showing graphs and tables of asset receivable information (e.g., car hire receivable information) for a particular month including least performing contracts, best performing contracts, and highest reclaim contracts for the month. FIG. 13 illustrates a second exemplary embodiment of a screen shot 1300 provided by the user interface of the system of FIG. 2 showing graphs and tables of asset receivable information (e.g., car hire receivable information) for a particular month including a contract summary and net earnings by car type.

In one embodiment, the user interface can facilitate user interaction and manipulation of at least a portion of the owner asset transaction data, the expected transaction data, and the discrepancy data to allow investigation of details associated with a detected discrepancy. The processing device may generate a claim associated with the detected discrepancy. The processing device may process claims by tracking paid claims, outstanding claims, and denied claims associated with the plurality of owner assets. The processing device may process claims for claim rectification and to confirm receipt of claims communications associated with the owner assets. The processing device may calculate trends of cost over time associated with one or more of the plurality of owner assets. The user interface present graphical depictions of the trends of cost over time. Such trends may be projected forward based on the empirical data.

Further, cost data and/or discrepancy rate data (preferably in graph form) may be compared for one asset versus another, by one class or group of assets versus another, or by other criteria. Other criteria may include identification of the asset user to investigate if a user's use incurs a different cost or discrepancy rate relative to another user or a user group average. Yet other criteria may include geographical areas to investigate if one region has different costs or discrepancy rates relative to other regions.

Systems and methods providing a user interface to facilitate at least the accessing, the reviewing, and the analyzing of owner asset transaction data are disclosed. Embodiments of the invention provide a controller having a communication device, programming logic, and a user interface. The communication device can receive owner asset transaction data for a plurality of owner assets. The user interface is operable to facilitate access of the owner asset transaction data by a user and the investigation of discrepancies between the owner asset transaction data and, for example, industry standard transaction data.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

1. A control system, comprising:
a communication device that is operable to communicate with a database comprising rail car hire receivable data generated by a rail car central clearing house and is further operable to receive selected rail car hire receivable data related to at least one of a plurality of owner rail cars, and the rail car hire receivable data is selected at least in part by user input;
a processor including a module that is operable to identify one or more rail car discrepancies in the rail car hire receivable data, wherein the one or more rail car discrepancies relate to one or more of rail car rate data, rail car time of use data, rail car distance traveled data, rail car payment data, rail car payee information, rail car type information, rail car cargo type information, rail car reclaims information, and rail car shipper/consignee information; and
a user interface that accepts user input from a user and that responds to the user input by accessing the database and displaying at least the selected set of rail car hire receivable data and the one or more identified rail car discrepancies.

2. The control system of claim 1, wherein the module is operable to compare the rail car hire receivable data to a set of industry standard rail car hire receivable data.

3. The control system of claim 2, wherein the module is further operable to determine a deviation in the rail car hire receivable data from the industry standard rail car hire receivable data.

4. The control system of claim 3, wherein the module is further operable to generate a claim based on the deviation in the rail car hire receivable data.

5. The control system of claim 1, wherein the module is further operable to compare at least a portion of first rail car movement data as recorded in the rail car hire receivable data to at least one of second rail car movement data obtained from a source other than that from the car hire receivable data or to rail car time and location data.

6. The control system of claim 1, wherein the user input comprises a rail car transaction level request for an individual rail car related to a single, unique rail car transaction.

7. (canceled)

8. The control system of claim 1, wherein the user interface is operable to display the set of rail car hire receivable data by category, wherein the category includes one or more of a rail car fleet category, a rail car type category, or an individual rail car category.

9. The control system of claim 1, wherein the module is operable to generate rail car trending information based on one or more owner rail cars and in response to user input, and the user interface is further operable to display the rail car trending information.

10. The control system of claim 1, wherein: the plurality of owner rail cars comprises a plurality of rail cars owned by a first entity and leased by the first entity to one or more second entities; the rail car hire receivable data comprises information of lease payments by the one or more second entities for leasing the plurality of rail cars and information of lease rates for the one or more second entities to lease the plurality of rail cars; and the control system generates a communication from the first entity to at least one of the second entities in response to a determination by the control system that one or more of the lease payments meet one or more designated criteria.

11. A method, comprising:
comparing rail car hire receivable data, received from a rail car central clearing house database, to at least one of modeled rail car transaction data or empirical rail car transaction data to identify a rail car discrepancy using a controller, wherein the rail car discrepancy relates to one of more of rail car rate data, rail car time of use data, rail car distance traveled data, rail car payment data, rail car payee information, rail car type information, rail car cargo type information, rail car reclaims information, and rail car shipper/consignee information; and
displaying selectably in response to an identified rail car discrepancy at least one of: the rail car hire receivable data, the modeled rail car transaction data or the empirical rail car transaction data, and further displaying rail car discrepancy data associated with the detected rail car discrepancy using a user interface of the controller.

12. The method of claim 11, further comprising generating and transmitting a claim based at least in part on the rail car discrepancy data.

13. The method of claim 11, further comprising displaying a claim history associated with the rail car hire receivable data, and the claim history including one or more of claims paid, claims outstanding, and claims denied.

14. The method of claim 11, further comprising compiling the rail car hire receivable data based on one or more of rail car rate data, rail car time of use data, rail car distance traveled data, or rail car payment data.

15. The method of claim 11, further comprising compiling the rail car hire receivable data based on one or more of rail car payee information, rail car type information, rail car cargo type, rail car reclaims information, and rail car shipment/consignee information.

16. The method of claim 11, wherein the detected rail car discrepancy is determined relative to at least one of a rail car rate, a rail car time of use, a rail car distance traveled, or a rail car payment.

17. A controller, comprising:
a communication device operable to retrieve rail car hire receivable data for at least one owner rail car from a rail car central clearing house database;
a processing device operable to receive and organize at least a portion of the rail car hire receivable data and expected rail car transaction data, and to generate rail car discrepancy data in response to discrepancies in the rail car hire receivable data relative to the expected rail car transaction data, wherein the rail car discrepancy data relates to one or more of rail car rate data, rail car time of use data, rail car distance traveled data, rail car payment data, rail car payee information, rail car type information, rail car cargo type information, rail car reclaims information, and rail car shipper/consignee information; and
a user interface configured for user interaction and operable to display at least a portion of the rail car hire receivable data, the expected rail car transaction data, and the rail car discrepancy data to allow investigation of details associated with a detected rail car discrepancy.

18. The controller of claim 17, wherein the processing device is further operable to generate a claim associated with the detected rail car discrepancy and to initiate the communication of that claim to a third party.

19. The controller of claim 17, wherein the processing device is operable to perform claims processing to at least track paid claims, outstanding claims, and denied claims associated with a plurality of owner rail cars.

20. The controller of claim 17, wherein the processing device is operable to calculate trends of cost over time associated with one or more of a plurality of owner rail cars, and the user interface is operable to present graphical depictions of the trends of cost over time.
